(19) United States
(12) Patent Application Publication
(10) Pub. No.: US 2016/0326992 A1
(43) Pub. Date: Nov. 10, 2016

(54) WATER CONDENSATE INJECTION APPLIED TO DEDICATED EGR ENGINE

(71) Applicant: GM GLOBAL TECHNOLOGY OPERATIONS LLC, Detroit, MI (US)

(72) Inventor: Edward J. KEATING, Ortonville, MI (US)

(21) Appl. No.: 14/705,584

(22) Filed: May 6, 2015

(51) Int. Cl. F02M 26/22

(52) U.S. Cl. CPC F02M 26/22

(57) ABSTRACT

An internal combustion engine includes an engine structure defining a plurality of cylinders. One of the plurality of cylinders is a dedicated exhaust gas recirculation cylinder wherein the exhaust passage in communication with the dedicated exhaust gas recirculation cylinder is an exhaust gas recirculation passage that is in communication with an intake manifold that is in communication with the plurality of intake passages. An exhaust gas recirculation cooler is in communication with the exhaust gas recirculation passage. A charge air cooler is in communication with an inlet air/exhaust gas recirculation mixer. A condensate collection vessel is provided for collecting condensate from one or both of the exhaust gas recirculation cooler and the charge air cooler. An injection system injects condensate from the condensate collection vessel into the plurality of cylinders.

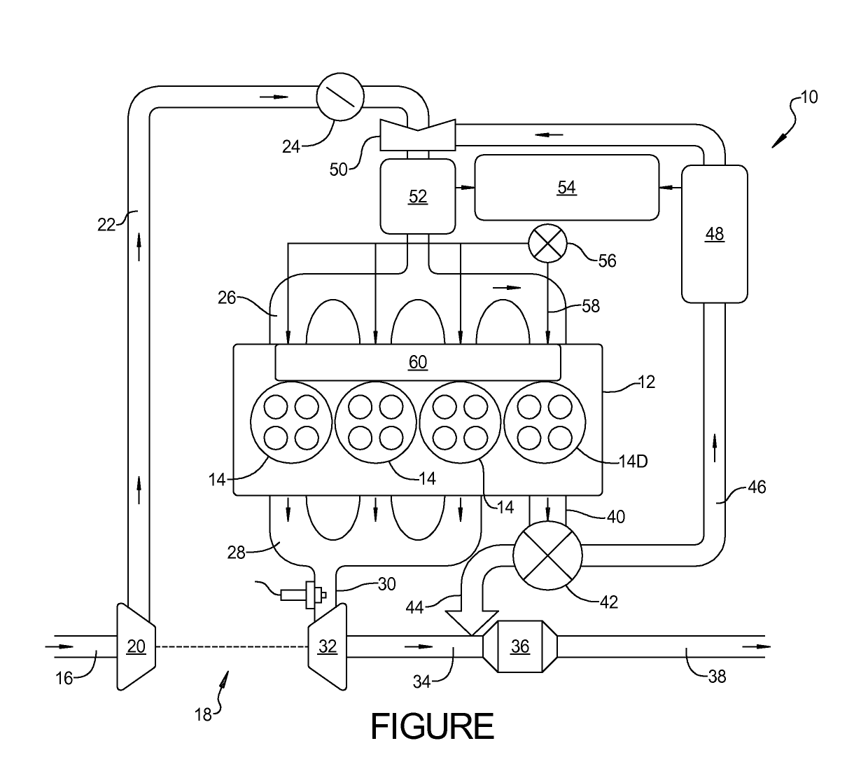

### FIELD

The present disclosure relates to internal combustion engines and more particularly to water condensate collection and injection for an internal combustion engine having a dedicated exhaust gas recirculation cylinder.

### BACKGROUND

This section provides background information related to the present disclosure which is not necessarily prior art.

Internal combustion engines utilizing a dedicated exhaust gas recirculation cylinder are generally known in the art. The dedicated exhaust gas recirculation system utilizes exhaust produced in an engine cylinder exclusively for reintroduction as exhaust gas recirculation. Vehicle fuel efficiency improvement has been demonstrated through the use of the dedicated exhaust gas recirculation cylinder technology.

Exhaust gas consists of 10-15% water. The exhaust gas recirculated in the dedicated exhaust gas recirculation engine is cooled first via an exhaust gas recirculation cooler and then again after mixing with induced air by a charge air cooler. With each cooling stage, significant condensate may occur based on atmospheric and operating conditions. Management of this condensate presents a challenge to dedicated exhaust gas recirculation technology implementation.

### SUMMARY

This section provides a general summary of the disclosure, and is not a comprehensive disclosure of its full scope or all of its features.

An internal combustion engine includes an engine structure defining a plurality of cylinders, a plurality of intake passages in communication with the plurality of cylinders and a plurality of exhaust passages in communication with the plurality of cylinders. One of the plurality of cylinders is a dedicated exhaust gas recirculation cylinder wherein the exhaust passage in communication with the dedicated exhaust gas recirculation cylinder is an exhaust gas recirculation passage that is in communication with an intake manifold that is in communication with the plurality of intake passages. An exhaust gas recirculation cooler is in communication with the exhaust gas recirculation. A charge air cooler is in communication with an inlet air/exhaust gas recirculation mixer. A condensate collection vessel is provided for collecting condensate from one or both of the exhaust gas recirculation cooler and the charge air cooler. An injection system injects condensate from the condensate collection vessel into the plurality of cylinders.

Further areas of applicability will become apparent from the description provided herein. The description and specific examples in this summary are intended for purposes of illustration only and are not intended to limit the scope of the present disclosure.

### DRAWING

The drawing described herein are for illustrative purposes only of selected embodiments and not all possible implementations, and are not intended to limit the scope of the present disclosure.

The FIGURE is a schematic diagram of an internal combustion engine having dedicated exhaust gas recirculation and utilizing a water condensate collection tank, pump and injection system for injecting water condensate into the cylinders to improve fuel efficiency.

Corresponding reference numerals indicate corresponding parts throughout the several views of the drawings.

### DETAILED DESCRIPTION

Example embodiments will now be described more fully with reference to the accompanying drawing.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

With reference to the FIGURE, an internal combustion engine 10 is shown including an engine structure 12 defining a plurality of cylinders 14, one of which is a dedicated exhaust gas recirculation (EGR) cylinder 14D. The engine 10 is shown as an in-line four-cylinder engine, although it should be understood that other engine arrangements including various numbers of cylinders and including V-configuration and other configurations can be utilized. The engine 10 can be supplied with inlet air via inlet 16 that can be supplied to a turbocharger 18 and compressed by a compressor 20 thereof. Intake air is then supplied through an intake passage 22 and a throttle valve 24 to an intake manifold 26 that supplies intake air to the intake ports of the plurality of cylinders 14.

All but one of the cylinders 14 are connected to an exhaust manifold 28 that is connected to an exhaust passage 30 that supplies exhaust gases to a turbine 32 of the turbocharger 18. The exhaust gases from the turbine 32 are then directed to an exhaust gas passage 34 that can include exhaust gas treatment system 36 that is connected to an exhaust pipe 38.

The dedicated EGR cylinder 14D includes an exhaust passage 40 that can be connected to a bypass valve 42 and a bypass passage 44 that is connected to the exhaust gas passage 34. The exhaust passage 40 is also connected to an exhaust gas recirculation passage 46 that includes an exhaust gas recirculation cooler 48. The exhaust gas recirculation passage 46 can be connected to a mixer 50 that mixes the recirculated exhaust gas with the compressed intake air from the intake passage 22. A water cooled charge air cooler 52 is provided in the intake passage to further cool the mixed intake air and recirculated exhaust gas.

A condensation collection tank 54 is provided for receiving condensation from the exhaust gas recirculation cooler 48 and the water cooled charge air cooler 52. The condensation from the exhaust gas recirculation cooler 48 and the water cooled charge air cooler 52 can optimally be gravity fed or pumped to the condensation collection tank 54. In addition, the condensation collection tank can be formed as an extension of one or both of the exhaust gas recirculation cooler 48 and the water cooled charge air cooler 52. A pump 56 is in communication with the condensate collection tank 54 and is in connection with water condensate injection passages 58 that are connected to condensate injectors 60 that are operable to inject condensate directly into each of the cylinders 14; 14D or alternatively into the intake ports leading into the cylinders 14; 14D. The condensate injectors are in addition to the engine fuel injectors.

It has been shown that the injection of water condensate in atomized form into the cylinders of an internal combustion engine can improve fuel efficiency by up to 3.5% due to improvements in the combustion process. The addition of a condensation collection tank, the pump 56 and condensate injectors 60 improves the fuel efficiency of the engine 10 while resolving a major challenge with the implementation of dedicated exhaust gas recirculation.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An internal combustion engine, comprising:
an engine structure defining a plurality of cylinders, a plurality of intake passages in communication with said plurality of cylinders and a plurality of exhaust passages in communication with the plurality of cylinders, one of said plurality of cylinders being a dedicated exhaust gas recirculation cylinder wherein the exhaust passage is communication with the dedicated exhaust gas recirculation cylinder is an exhaust gas recirculation passage that is in communication with an intake manifold that is in communication with the plurality of intake passages;
an exhaust gas recirculation cooler in communication with the exhaust gas recirculation passage;
a condensate collection vessel for collecting condensate from the exhaust gas recirculation cooler; and
an injection system for injecting condensate from the condensate collection vessel into the plurality of cylinders.

2. An internal combustion engine, comprising:
an engine structure defining a plurality of cylinders, a plurality of intake passages in communication with said plurality of cylinders and a plurality of exhaust passages in communication with the plurality of cylinders, one of said plurality of cylinders being a dedicated exhaust gas recirculation cylinder wherein the exhaust passage is communication with the dedicated exhaust gas recirculation cylinder is an exhaust gas recirculation passage that is in communication with an intake manifold that is in communication with the plurality of intake passages;
a charge air cooler in communication with an inlet air/exhaust gas recirculation mixer;
a condensate collection vessel for collecting condensate from the charge air cooler; and
an injection system for injecting condensate from the condensate collection vessel into the plurality of cylinders.

3. An internal combustion engine, comprising:
an engine structure defining a plurality of cylinders, a plurality of intake passages in communication with said plurality of cylinders and a plurality of exhaust passages in communication with the plurality of cylinders, one of said plurality of cylinders being a dedicated exhaust gas recirculation cylinder wherein the exhaust passage is communication with the dedicated exhaust gas recirculation cylinder is an exhaust gas recirculation passage that is in communication with an intake manifold that is in communication with the plurality of intake passages;
an exhaust gas recirculation cooler in communication with the exhaust gas recirculation passage;
a charge air cooler in communication with an inlet air/exhaust gas recirculation mixer;
a condensate collection vessel for collecting condensate from the exhaust gas recirculation cooler and the charge air cooler; and
an injection system for injecting condensate from the condensate collection vessel into the plurality of cylinders.
